(19) United States
(12) Patent Application Publication
(10) Pub. No.: US 2008/0280272 A1
(43) Pub. Date: Nov. 13, 2008

(54) APPARATUS AND SYSTEM FOR READING TO STUDENTS

(76) Inventor: LeRoy W. Titus, St. Petersburg, FL (US)

Correspondence Address: Michael J. Colitz, III;Holland & Knight LLP, P.O. Box 1288, Tampa, FL, 33601-1288, US

(21) Appl. No.: 11/747,901

(22) Filed: May 12, 2007

(51) Int. Cl. G09B 17/00

(52) U.S. Cl. 434/178

(57) ABSTRACT

Disclosed is an apparatus and system for reading to students. The system includes an especially designed book with a corresponding card. As is typical, the book includes front and back covers and further includes textual material and pictures on the internal pages. However, in accordance with the invention, one of the covers includes an elongated slot. A card is provided that can be selectively positioned within the slot of the cover such that the card hangs from the cover of the book. The card includes text that corresponds to the text on the pages of the book. By securing the card from the cover of the book, a user can display the pages of the book outwardly while at the same time reading the displayed material from behind the book.

### BACKGROUND OF THE INVENTION

1. Field of the Invention

This invention relates to a system and apparatus for teaching children how to read. More particularly, the present invention relates to a book that enables a user to read to a group of students while at the same time displaying the text that is being read.

2. Description of the Background Art

The importance of teaching children to read cannot be overstated. Reading skills are critical to cognitive development and are the foundation for all other learning. For this reason, parents and teachers alike always strive to develop reading skills at the youngest possible age. The most time tested manner of teaching reading skills is to read aloud to the child as the corresponding text is being displayed. The aim of this technique is to show the child a word while at the same time pronouncing it and demonstrating its meaning. This is typically achieved with the parent or teacher sitting along side the child while both view the book. However, this technique has a drawback in that with a reader in front of the book at most one other person can view the text. The technique can also be accomplished with a parent or teacher displaying a book outwardly to a child or a group of children. However, this technique has the drawback of requiring the parent or teacher to lean forward and turn his or her head in order to view the text being displayed. Over the years, various efforts have been made to make to overcome these shortcoming and thereby simplify the task of reading to children.

One example of this effort is embodied in U.S. Pat. No. 6,932,609 to Bozek. This reference discloses a book configuration for teaching literacy. The book contains sheets that are configured such that persons located on opposite sides of the book see substantially the same content. U.S. Pat. No. 5,626,365 to Petteway further discloses a two-way book that is especially useful when reading to a group of young children. The book is comprised of page pairs with corresponding indicia. It its demonstrate mode, one page pair faces the reader while the second page pair faces the listener. Another example is demonstrated in U.S. Pat. No. 5,921,579 to Sadler. Sadler discloses a double-sided stand-up book that allows two persons looking at the book to view independent textual material. Finally, U.S. Pat. No. 5,033,964 to Phelps discloses a book for joint reading. The book includes removable pages that correspond numerically to fixed pages in the book and which include material corresponding to the material on the fixed pages.

Although each of the above referenced inventions achieves its individual objective, none of the references is directed to an apparatus and system for reading to students that is functional, easy to use, and portable.

### SUMMARY OF THE INVENTION

It is one of the objectives of this invention to enable book text to be displayed to one or more students while at the same time allowing the reader to easily view the displayed text.

It is also one of the objectives of the present invention to provide an apparatus and system for reading to students that is portable, storable, and which is easy to use.

It is a further object of this invention is to removably secure book text to the front or back cover of a book to thereby enable book text to be read to students while it is being displayed.

It is yet another object of this invention to provide an apparatus for reading to children this is decorative for capturing the attention of children.

These and other objectives of the invention are achieved by providing a system for reading to another person that includes a book having front and back covers with a plurality of pages positioned therebetween. At least some of the pages of the book contain book text. An opening is formed within one of the covers and a sheet with an edge is positioned within the opening. The sheet contains text that corresponds to the book text. With the system a user can display the book text while reading the corresponding text from the sheet. The sheet can thereafter be removed and used as a bookmark.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a perspective view of the system of the present invention.

FIG. 2 is a rear elevational view of the system of the present invention.

FIG. 3 is a front elevational view of the system of the present invention.

FIG. 4 is a view of the card that forms part of the system of the present invention.

FIG. 5 is a view taken along line 5-5 of FIG. 4.

FIG. 6 is a partially exploded view showing the card being inserted into the book of the present invention.

FIG. 7 is an elevational view of an alternative decorative embodiment of the card of the present invention.

FIG. 8 is a view taken along line 8-8 of FIG. 7.

Similar reference characters refer to similar parts throughout the several views of the drawings.

### DETAILED DESCRIPTION OF THE PREFERRED EMBODIMENT

The present invention relates to an apparatus and system for reading to students. The system includes an especially designed book with a corresponding card. As is typical, the book includes front and back covers and further includes textual material and pictures on the internal pages. However, in accordance with the invention, one of the covers includes an elongated slot. A card is provided that can be selectively positioned within the slot of the cover such that the card hangs from the cover of the book. The card includes text that corresponds to the text on the pages of the book. By securing the card from the cover of the book, a user can display the pages of the book outwardly while at the same time reading the displayed material from behind the book. The various features of the present invention, and the manner in which they interrelate, will be described in greater detail hereinafter.

With reference now to FIG. 1, the system 20 of the present invention is illustrated. One specific application for the system of the present invention is to allow books to be read to children. Thus, the specific book 22 illustrated in FIG. 1 is a children's book. Book 22 includes upper and lower extents (24 and 26) and rigid front and back covers (28 and 32). Book covers 28 and 32 can have varying heights and widths to create books of varying sizes and shapes. Those skilled in the book making arts will also appreciate that the present invention is not limited to hard cover books, but rather can be used in connection with soft cover books. Books both with and without a spine will likewise benefit from the present invention. Nonetheless, book 22 depicted in FIG. 1 includes a spine 34 that serves to interconnect covers 28 and 32 as well as to secure a plurality of pages 36 positioned intermediate covers 28 and 32.

As is typical, at least some of the pages 36 of book 22 will contain text 38. Pages 36 may likewise include illustrations or pictures 40 (note FIG. 3). Pages 36 may further include special effects, such as sound recordings, moving figures, or pop-up shapes, all of which are known in the book making arts. The nature of the materials included in book 22 will, of course, depend upon the intended age of the reader.

With reference to FIGS. 1, 2, and 6, a slot 42 is formed within book 22. Namely, as illustrated, front cover 28 of book 22 includes slot or opening 42. In the preferred embodiment, slot 42 is elongated and is formed along the width of front cover 28 at upper extent 24 of book 22. Slot 42 forms a small pocket into which a sheet of material can be inserted in a manner described in greater detail hereinafter. Although the preferred embodiment has been described with slot 42 being formed in front cover 28, the present invention can also be carried out with slot 42 being formed within back cover 32 of book 22. Slot 42 can likewise be positioned at other locations other than upper extent 24.

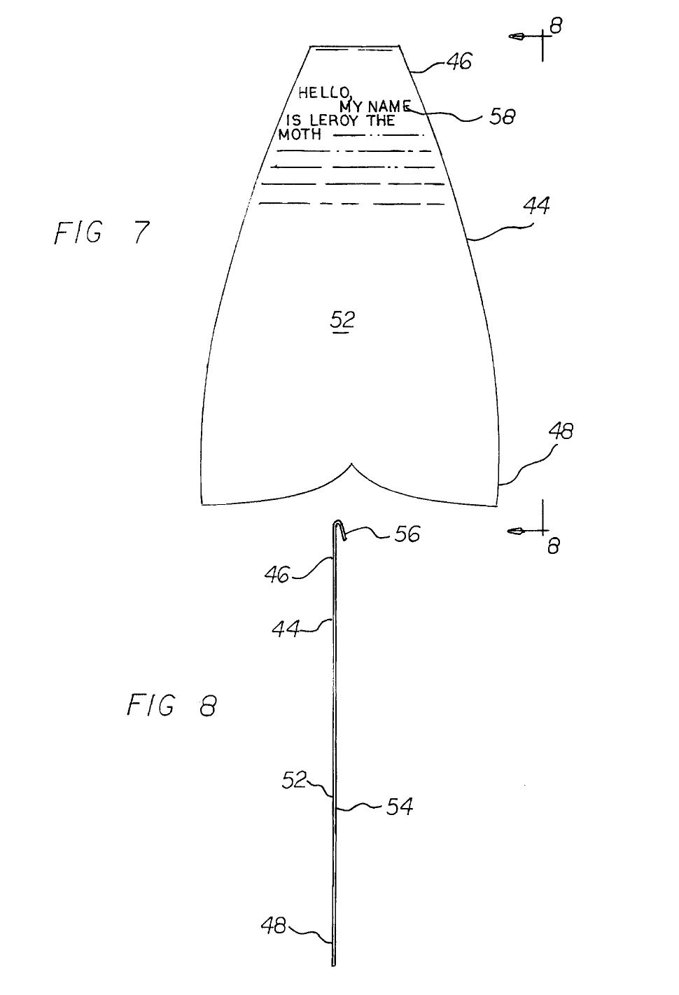

Card 44 depicted is of an elongated shape. However, card 44 can also be formed into a decorative shape that will capture and hold the attention of children. The use of cards having other shapes and sizes is also within the scope of the present invention. The decorative shape illustrated in FIG. 7 is in the form of moth. The decorative shape selected can, for example, complement the subject of the story. In use, the decorative shape of card 44 will be viewable by the students insomuch as a lower extent 48 of card 44 extends below the lower extent 26 of book 22.

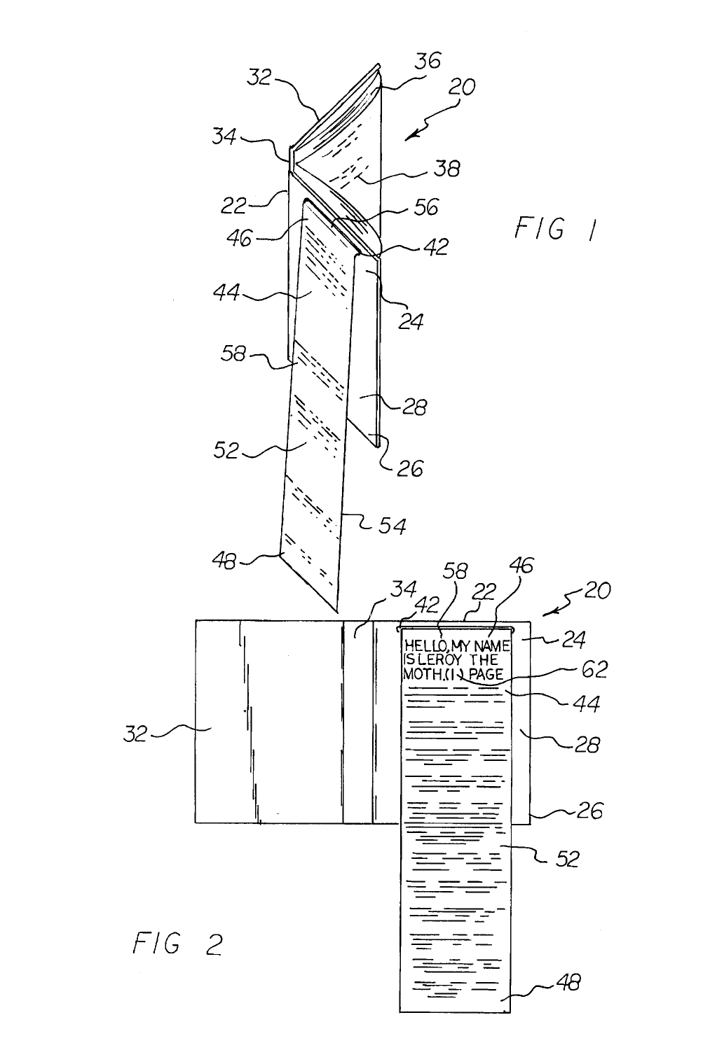

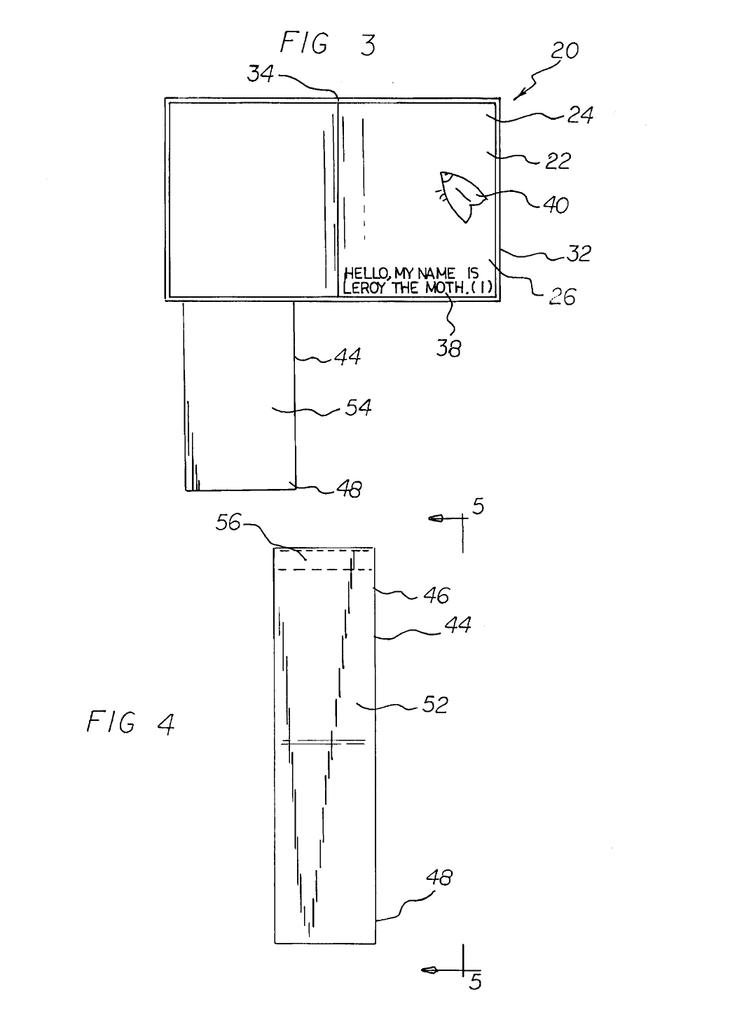

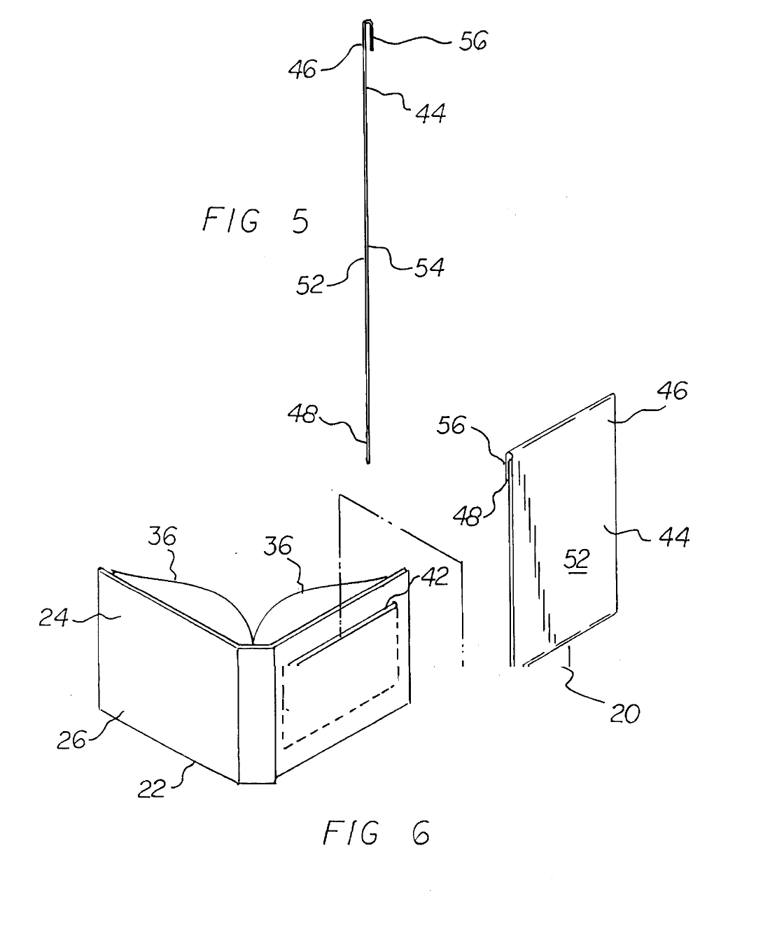

Regardless of the shape used, card 44 is defined by an upper extent 46, a lower extent 48, and forward and rearward surfaces (52 and 54). In the preferred embodiment card 44 is laminated and rigid. However, the invention can also be carried out using an non rigid sheet. With reference to FIGS. 5 and 8, it can be seen that upper extent 46 of card 44 is bent over into a u-shaped or v-shaped hook 56. Hook 56 has a width that is less than the width of elongated slot 42. As illustrated, v-shaped hook 56 is positioned within the elongated slot 42 and corresponding pocket of book 22 such that card 44 hangs from and is secured to front cover 28 of book 22. Again, as noted above, the invention can also be carried out by securing card 44 to back cover 32 of book 22 in a similar fashion. Either way, with card 44 secured to book 22, forward surface 52 of card 44 is visible from the back side of book 22. As specifically noted in FIG. 2, forward surface 52 of card 44 contains text 58 and reference numerals 62. Text 58 upon card 44 is identical to text 38 within book 22. Additionally, the reference numerals 62 on card 44 indicate which page 36 of book 22 card text 58 is located. In order to condense the entire text 38 onto card 44, card text 58 is in a substantially smaller font size than book text 38. Further economy of space is realized by eliminating pictures or illustrations 40 from card 44. Thus, reference numerals 62 upon card 44 will indicate, for example, that the first paragraph of text 58 on card 44 corresponds to the first page 36 of book text 38.

In use, a user will first position card 44 within the front cover 28 of book 22 by placing v-shaped hook 56 into slot 42. Once so positioned, card 44 will hang from front cover 28. The user can then hold lower extent 26 of book 22 to display the contents of book 22 outwardly to others. In this position, the user will be viewing the front and back covers (38 and 32)of book 22. Thus, card 44 will be displayed to the user. The user can then read the text 58 upon card 44, while at the same time the page text 38 and illustrations 40 are beings displayed to others. The reference numerals 62 upon card 44 will indicate to the user when a page 36 should be turned. In this manner, the user will be able to more efficiently and effectively read book 22 to others. When done, card 44 can be removed and placed between pages 36 to function as a book mark used to facilitate storage.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A system for reading to students comprising:
a children's book having upper and lower extents and rigid front and back covers, each of the covers having a width, a spine interconnecting the covers, a plurality of pages positioned intermediate the front and back covers and secured to the spine, at least some of the pages containing book text and pictures, an elongated slot formed along the width of the front cover at the upper extent of the book;
a laminated card of a decorative shape, the card having an upper extent, a lower extent, and forward and rearward surfaces, the upper extent of the card being bent over into a v-shaped hook, the v-shaped hook having a width that is less than the elongated slot of the book, the v-shaped hook being positioned within the elongated slot of the book such that the card hangs from and is secured to the front cover of the book with the forward surface of the card being visible, the forward surface of the card containing card text and card reference numerals, the card text being identical to the book text, with the card reference numerals indicating which page of the book the card text is located;
wherein with the card hanging from the front cover of the book, a user can hold the lower extent of the book to display the book text and pictures to students while at the same time reading the book text by way of the card text and card reference numerals.

2. A system for reading to another person comprising:
a book having front and back covers with a plurality of pages positioned therebetween, at least some of the pages of the book containing book text, an opening formed within one of the covers;
a sheet with an edge that is positioned within the opening of the book cover, the sheet containing text that corresponds to the book text;
wherein a user can display the book text while reading the corresponding text from the sheet.

3. The system for reading as described in claim 2 wherein the opening is formed within the front cover.

4. The system for reading as described in claim 2 wherein the opening is formed within the back cover.

5. The system for reading as described in claim 2 wherein the sheet is a laminated card.

6. The system for reading as described in claim 2 wherein the sheet has a decorative shape.

7. The system for reading as described in claim 2 wherein the sheet includes reference characters that indicate which page of the book the text of the sheet is located.

8. The system for reading as described in claim 2 wherein the sheet also functions as a bookmark.

9. The system for reading as described in claim 2 wherein the sheet has an upper edge that is bent into a v-shape and which is positioned within the opening of the book.

10. An apparatus for reading to another person comprising:
a children's book having upper and lower extents and rigid front and back covers, each of the covers having a width, a spine interconnecting the covers, a plurality of pages positioned intermediate the front and back covers and secured to the spine, at least some of the pages containing book text and pictures, an elongated slot formed along the width of the front cover at the upper extent of the book;
wherein a user can hold the lower extent of the book to display the book text and pictures to students while at the same time reading the book text by way of a card positioned within the elongated slot.
